(19) United States
(12) Patent Application Publication
(10) Pub. No.: US 2017/0012501 A1
(43) Pub. Date: Jan. 12, 2017

(54) Electric Motor, Scraping Member, and Rotor

(71) Applicant: HITACHI, LTD., Chiyoda-ku, Tokyo (JP)

(72) Inventors: Kentaroh SANO, Tokyo (JP); Atsuo NISHIHARA, Tokyo (JP); Itsurou SAWADA, Tokyo (JP)

(21) Appl. No.: 15/113,169

(22) PCT Filed: Mar. 26, 2014
(86) PCT No.: PCT/JP2014/058434

§ 371 Date: Jul. 21, 2016

(51) Int. Cl. H02K 9/19

(52) U.S. Cl. CPC H02K 9/19

(57) ABSTRACT

A scraping member for scraping up an oil coolant while the scraping member is being rotated in conjunction with rotation of a rotor, the scraping member being provided on a side-portion side of the rotor in an axial direction of a rotating shaft, is provided. The scraping member has a recessed portion that forms an opening serving as an inlet port of the oil coolant on an inner circumferential surface in a radial direction of the rotating shaft or on a side surface in the axial direction of the rotating shaft and has an oil introduction hole passed from an inner side to an outer side in the radial direction of the rotating shaft in the recessed portion.

### TECHNICAL FIELD

The present invention relates to an electric motor, a scraping member, and a rotor.

### BACKGROUND ART

In the fields of railroads, vehicles, industrial equipment, and the like, electric motors are used in various ways.

A background art in this technical field is JP-A-2011-120417 (PTL 1) This publication discloses that “A scraping member 30 integrally rotating with a rotor 20 to scrape up oil stored in an oil reservoir is included, and the scraping member 30 includes a main body portion 31 positioned on one side of a stator 10 in an axial direction and on the outside of a surface facing an inner circumference of a stator core 11 in a radial direction.” (See Abstract).

Another background art in this technical field is JP-A-2010-60026 (PTL 2). This publication discloses that “A scraping ring 50 having scraping teeth 56, each of which is formed to have a hollow portion thereinside and has communication opening 58 through which lubricating oil can be introduced into the inside thereof and an opening 56c through which the lubricating oil that has flown into the inside through the communication opening 58 can be discharged, is fitted to an inner circumferential surface of a rotor 24 by pressing. With this, when the rotor 24 is rotated, the scraping teeth. 56 scrape up the lubricating oil while storing the lubricating oil thereinside. As a result, a greater amount of lubricating oil can be scraped up. In addition, because it is only necessary to form the hollow scraping teeth 56, it is possible to efficiently scrape up the lubricating oil while suppressing an increase in friction at the time of scraping up the lubricating oil.” (See Abstract).

Still another background art in this technical field is WO 2010/067426 (PTL 3). This publication discloses that “A rotating electrical machine includes a rotor 18 in which projected poles 80, each of which has circumferential both side surfaces 80a and 80b and a radial end surface 80c and is projected toward the outside of a rotating shaft 12 in a radial direction, are arranged at predetermined intervals in a circumferential direction, the rotating electrical machine operating in a state in which lubricating oil and air are present in a motor chamber 10a receiving the rotor 18, and each projected pole 80 has a fluid flow channel 90 through which, when the rotor 18 rotates, the lubricating oil and air pass from an opening 81a formed in the one circumferential side surface 80a to an opening 81b formed in the other circumferential side surface 80b.” (See Abstract).

### CITATION LIST

### Patent Literatures

[PTL 1] JP-A-2011-120417

[PTL 2] JP-A-2010-60026

[PTL 3] WO 2010/067426

[PTL 4] JP-A-2009-261137

### SUMMARY OF INVENTION

### Technical Problem

In an electric motor such as an inner rotor electric motor, an oil coolant is introduced into a housing thereof to cool a coil included therein. In this case, however, the oil coolant stagnates on a lower side of the housing, and therefore, although a coil positioned on a lower side of the electric motor can be cooled, the coil positioned on an upper side thereof cannot be adequately cooled because the oil coolant cannot be circulated.

In view of this, for example, PTLs 1 to 3 described above disclose that the scraping member, the scraping ring, the projected poles, or the like is/are attached to the rotor and the oil coolant is scraped up by those members.

However, even in the case where the oil coolant is scraped up by using the scraping member having a comparatively simple plate shape, the scraping ring, the projected poles, or the like, an adequate amount of oil coolant cannot he supplied to an upper part of the coil.

In view of this, an object of the invention is to provide an adequate amount of oil coolant to a coil of an electric motor.

### Solution to Problem

In order to solve the above problem, in an embodiment of the invention, a scraping member for scraping up an oil coolant while the scraping member is being rotated in conjunction with rotation of a rotor, the scraping member being provided on a side-portion side of the rotor in a direction of a rotating shaft, has a recessed portion that forms an opening serving as an inlet port of the oil coolant on an inner circumferential surface in a radial direction of the rotating shaft or on a side surface in an axial direction of the rotating shaft and has an oil introduction on hole passed from an inner side to an outer side in the radial direction in the recessed portion.

### Advantageous Effects of Invention

According to the invention, it is possible to provide an electric motor and a scraping member, each of which is capable of providing an adequate amount of oil coolant to a coil of an electric motor.

Problems, configurations, and effects other than those described above will be disclosed by the description of embodiments described below.

### BRIEF DESCRIPTION OF DRAWINGS

FIG. 1 is a longitudinal sectional view of an electric motor according to Example 1 of the invention.

FIG. 2(a) is an enlarged longitudinal sectional view of a right part of the electric motor according to Example 1 of the invention. FIG. 2(b) is a sectional view taken along the line A-A in FIG. 2(a).

FIGS. 3 illustrate a scraping member according to Example 1 of the invention which is longitudinally cut and is seen from an inner side in a radial direction. FIG. 3(a) to FIG. 3(e) illustrate different configuration examples of the scraping member.

FIG. 4(a) and FIG. 4(h) are partially enlarged longitudinal sectional views, each of which illustrates a portion above a scraping member of an electric motor according to a modification example of Example 1.

FIG. 5(a) is an enlarged longitudinal sectional view of a right part of an electric motor according to a modification example of Example 1, and FIG. 5(b) is a sectional view taken along the line B-B in FIG. 5(a).

FIG. 6(a) is an enlarged longitudinal sectional view of a right part of an electric motor according to a modification example of Example 1, and FIG. 6(b) is a sectional view taken along the line C-C in FIG. 6(a).

FIG. 7 is an enlarged longitudinal sectional view of a right part of an electric motor according to a modification example of Example 1.

FIG. 8(a) is a longitudinal sectional view of a right part of an electric motor according to Example 2. FIG. 8(b) is a sectional view taken along the line D-D in FIG. 8(a).

FIG. 9 illustrates a scraping member according to Example 2 which is longitudinally cut and is seen from an inner side in a radial direction.

FIG. 10(a) is a longitudinal sectional view of a right part of an electric motor according to Example 3. FIG. 10(b) is a sectional view taken along the line E-E in FIG. 10(a).

FIG. 11 illustrates a scraping member according to Example 3 which is longitudinally cut and is seen from an inner side in a radial direction.

### DESCRIPTION OF EMBODIMENTS

Examples of the invention will be described below with reference to the drawings.

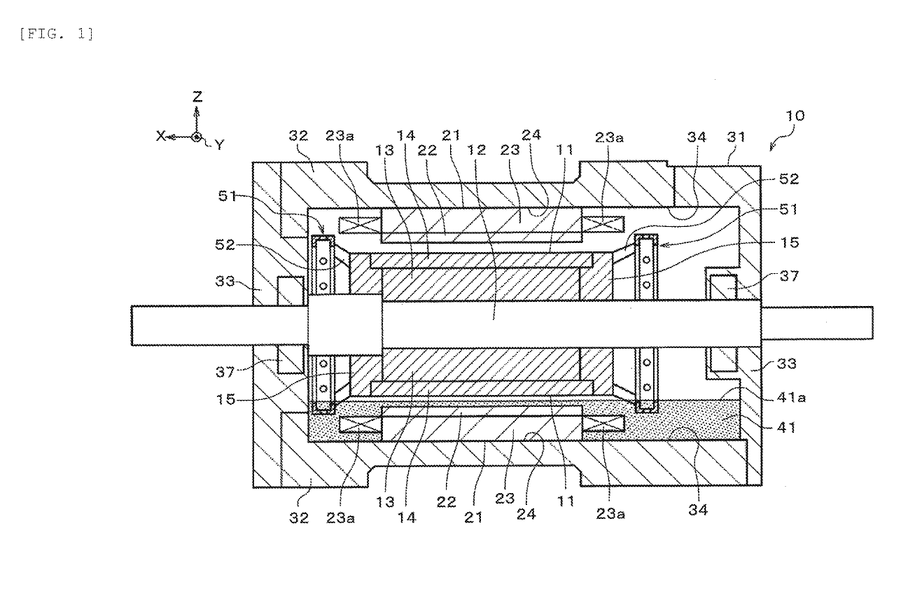

Note that an X-axis, a Y-axis, and a Z-axis in this description and the drawings are orthogonal to one another, and the X-axis and the Y-axis are axes within a predetermined plane, whereas the Z-axis is an axis orthogonal to the predetermined plane. In this embodiment, when directions are shown on the basis of the case where FIG. 1 is seen in a forward direction in FIG. 1 which is in parallel to the Y-axis, “up” (vertically upward) is an arrow direction of the Z-axis and “down” (vertically downward) is a direction opposite thereto, “left” is an arrow direction of the X-axis and “right” is a direction opposite thereto, and “forward” is a forward direction orthogonal to the sheet and is an arrow direction of the Y-axis and “backward” is a direction opposite thereto.

### EXAMPLE 1

In this example, an example of an electric motor capable of providing an adequate amount of oil cool ant to a coil of the electric motor by using a circular scraping member will be described.

FIG. 1 is a longitudinal sectional view of the electric motor according to this example.

This electric motor 10 is, for example, a three-phase squirrel-cage induction motor and includes a rotor (rotor main body) 11, a stator 21 surrounding the rotor 11, and a housing 31 receiving the rotor 11 and the stator 21. That is, the electric motor 10 is an inner rotor electric motor.

The rotor 11 includes a rotor core 13 fixed to a rotating shaft 12, a copper bar 14 for supplying a current, the copper bar being fitted into a portion obtained by hollowing out an outer circumferential surface of the rotor core 13, and end rings 15 fitted from left and right sides of the rotor core 13 in order to fix the copper bar 14 to the rotor core 13.

The stator 21 includes a core back 24 formed on an inner circumferential surface 34 of the housing 31, a plurality of teeth 22 arranged at regular intervals in a circumferential direction on the inner circumferential surface 34 of the housing and a coil (coil body portion) 23 wound around the teeth 22. The core back 24 supports the teeth 22 and serves as a path through which lines of magnetic force generated by a current flowing through the coil 23 pass. Left and right end portions (coil end portions) 23a of the coil 23 are projected leftward and rightward from each of the teeth 22.

The housing 31 forms apart of the stator 21. The housing 31 includes a housing body portion 32 in which the core back 24 is formed on the inner circumferential surface 34 thereof and end brackets 33 fixed to both left and right sides of the housing body portion 32. Bearings 37 are provided to the left and right end brackets, respectively, and rotatably bear the rotating shaft 12.

In the electric motor 10 having such a basic configuration, in the case where a current is supplied to the coil 23 to generate a magnetic field on the stator 21 side and the magnetic field is generated to be rotated in circumferential direction of the electric motor 10 by regulating the current, a current is induced in the copper bar 14 by electromagnetic induction. Further, in the case where the magnetic field is continuously rotated in the electric motor 10, the current flowing through the copper bar 14 crosses the magnetic field, and therefore electromagnetic force acts on the copper bar 14 to thereby rotate the rotor 11.

An oil coolant 41 for cooling is received in the housing 31 of the electric motor 10. The oil coolant 41 stagnates on a lower side of the housing 31.

A scraping member 51 is provided on a right-part side in an axial direction of the rotating shaft 12 on a right side of the rotor core 13 of the rotor 11. Similarly, another scraping member 51 is also provided on a left-part side in the axial direction of the rotating shaft 12 on a left side of the rotor core 13. Each of the scraping members 51 is supported by a plurality of support members 52 fixed to the rotor core 13. A diameter size of the scraping member 51 is larger than a diameter size of the rotor 11, and a lower side of the scraping member 51 is soaked in the oil coolant 41. The scraping member 51 scrapes up the oil coolant 41 while being rotated in conjunction with rotation of the rotor 11.

Herein, in the case where the scraping member 51 is a member having a comparatively simple flat-plate shape or the like, an adequate amount of oil coolant 41 cannot be scraped up and be accurately supplied to the coil 23, and therefore the coil 23 cannot be adequately cooled. Therefore, the scraping member 51 having a configuration in which an adequate amount of oil coolant. 41 can be scraped up and be accurately supplied to the coil 23 is needed. Hereinafter, the scraping member 51 that achieves the above configuration and the like will be described.

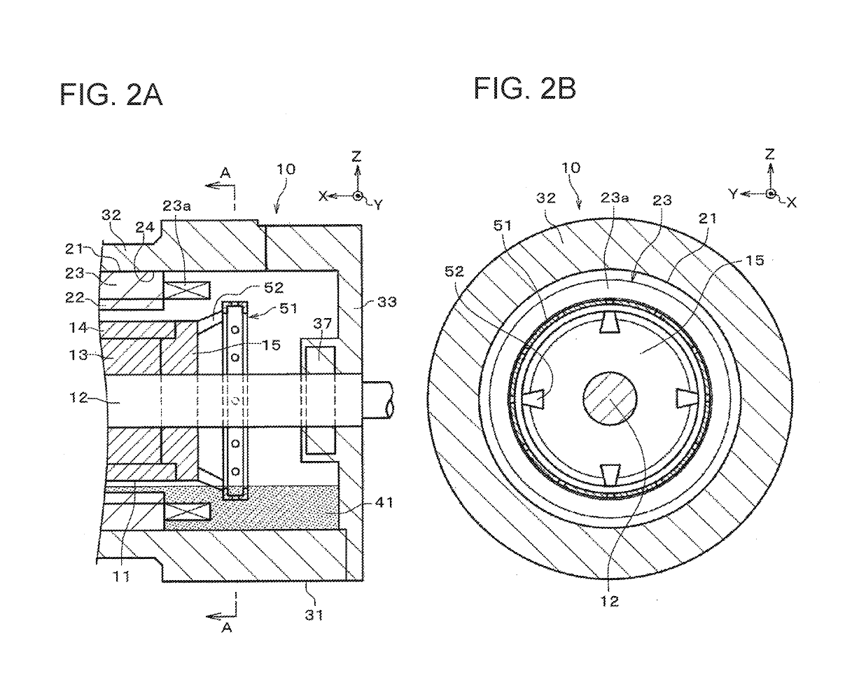

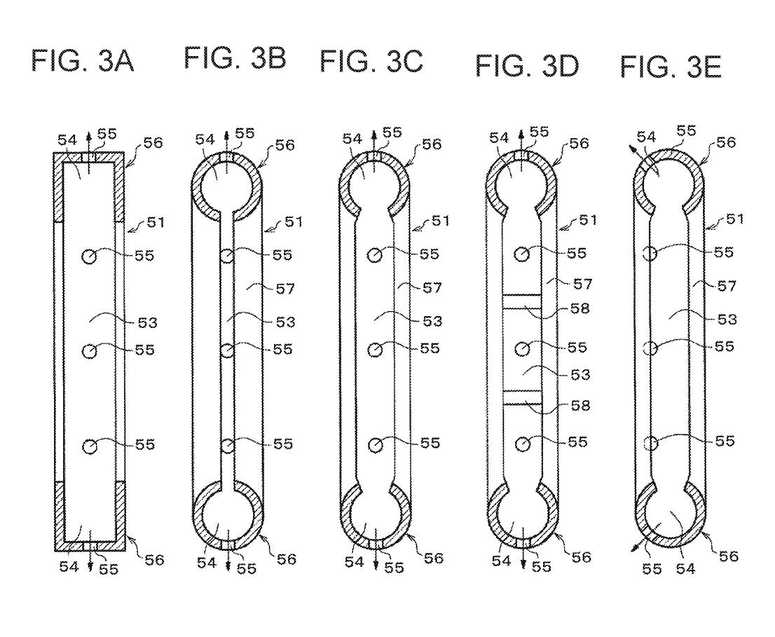

FIG. 2(a) is an enlarged longitudinal sectional view of a right part of the electric motor 10. FIG. 2(b) is a sectional view taken along the line A-A in FIG. 2(a). The sectional view of FIG. 2(a) illustrates a section obtained by cutting the scraping member 51 in a vertical direction. FIG. 3 illustrate the scraping member 51 which is longitudinally cut and is seen from an inner side in a radial direction. FIG. 3(a) to FIG. 3(e) illustrate different configuration examples of the scraping member 51.

A sectional shape in FIG. 2(b) is a sectional shape of the scraping member 51 illustrated in FIG.(a)

In each of the examples in FIG. 3, a recessed portion 54 that forms an opening 53 serving as an inlet port of the oil coolant 41 is formed on an inner circumferential surface of the scraping member 51 in a radial direction of the rotating shaft 12 or on a side surface of the scraping member 51 in the axial direction thereof (an inner circumferential surface 57 in each of the examples in FIG. 3(b) to FIG. 3(e), and the whole inner circumferential surface in the example in FIG. 3(a) A plurality of oil introduction holes 55 passed from an inner side to an outer side in the radial direction of the rotating shaft 12 are formed in the recessed portion 54 at predetermined intervals.

Therefore, when the scraping member 51 rotated in conjunction with rotation of the rotor 11 is soaked in the oil coolant 41, the oil coolant 41 flows through the opening 53 and the oil coolant 41 is scooped up by the recessed portion 54. Then, the oil coolant 41 in the recessed portion 54 is lifted upward in accordance with rotation of the scraping member 51 and is discharged by centrifugal force to the outside of the rotating shaft 12 in the radial direction through the oil introduction holes 55.

As described, above, because the oil coolant 41 is scooped up and is drawn up by the recessed portion 54 and the oil coolant 41 is discharged by centrifugal force to the outside of the rotating shaft 12 in the radial direction through the oil introduction holes 55, it is possible to supply an adequate amount of oil coolant 41 to the coil 23 (in particular, coil end portion 23a) and adequately cool an upper part of the coil 23.

A portion of an outer circumferential surface 56 (surface opposite to the inner circumferential surface 57) of the scraping member 51 in the radial direction of the rotating shaft 12, the portion being brought into contact with the oil coolant 41, has the same sectional shape in the axial direction of the rotating shaft 12 over the entire circumference except for portions where the oil introduction holes 55 are formed. In addition, the portion of the circumferential surface 56, which is brought into contact with the oil coolant 41, is equally distant from the center of rotation of the scraping member 51 (the shaft center of the rotating shaft 12).

Thus, a surface shape and a size of the portion of the scraping member 51 to be sequentially soaked in the oil coolant 41 by rotation of the scraping member 51, a depth at which the portion thereof is immersed in the oil coolant 41, and the like are always constant. Therefore, a resistance applied by the oil coolant 41 when the scraping member 51 rotates can be comparatively small, and rotation of the rotor 11 can be satisfactorily maintained.

The scraping member 51 in each of the examples in FIG. 3(a) to FIG. 3(e) is a circular member, has a hollow portion thereinside, and forms the recessed portion 54.

The example in FIG. 3(a) is an example of the scraping member 51 illustrated in FIG. 1 and FIG. 2. The scraping member 51 has a rectangular sectional shape in the axial direction of the rotating shaft 12, and an inner surface of the recessed portion 54 also has a rectangular sectional shape.

In each of the examples in FIG. 3(b) to FIG. 3(e), the scraping member 51 has a substantially circular sectional shape in the axial direction of the rotating shaft 12, and the inner surface of the recessed portion 54 also has a substantially circular sectional shape.

The width of the opening 53 is wider in the examples of FIG. 3(c) to FIG. 3(e) than in the example in FIG. 3(b), and the opening 53 becomes larger from the inside toward the outside.

Therefore, in the examples of FIG. 3(c) to FIG. 3(e), a large amount of oil can be drawn up by the recessed portion 54 at a time, as compared with the example in FIG. 3(b).

In the example in FIG. 3(d), the inside of the recessed portion 54 is partitioned by partition members 58 formed between the oil introduction holes 55.

Therefore, in the example in FIG. 3(d), the oil coolant 41 can be lifted up by the partition members 58, and thus it is possible to scrape up a large amount of oil coolant 41, as compared with other examples.

In the example in FIG. 3(e), the oil introduction holes 55 from an inner side (recessed portion 54 side) to an outer side of the scraping member 51 in the radial direction are directed toward the coil 23 (coil end portion 23a) of the stator 21.

Therefore, in the example of FIG. 3(e), the oil coolant 41 can be accurately supplied to the coil 23 (coil end portion 23a) and the coil 23 (coil end portion 23a) can be effectively cooled.

Referring back to FIG. 1, a height of a liquid surface 41a of the oil coolant 41 stored in the housing 31 is set so as not to reach an outer circumferential surface of the rotor 11.

Therefore, the rotor 11 is not brought into direct contact with the oil coolant 41 and does not directly receive a resistance from the oil coolant 41, and thus rotation of the rotor 11 can be satisfactorily maintained.

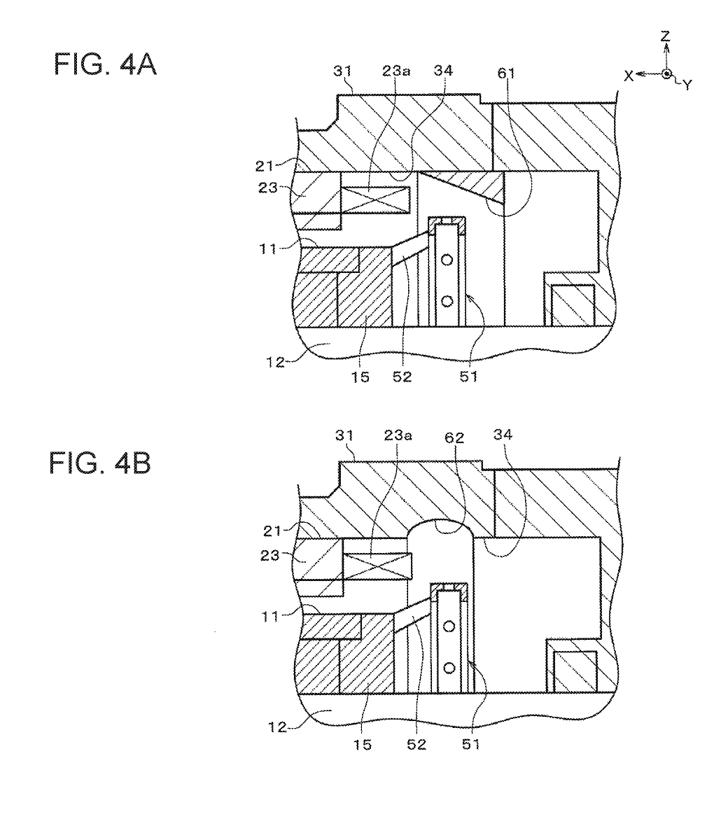

FIG. 4(a) and FIG. 4(b) are partially enlarged longitudinal sectional views, each of which illustrates a portion above the scraping member 51 of the electric motor 10 according to a modification example of this example. In the example of FIG. 4(a), a reflection portion 61, which is an inclined surface projected from the inner circumferential surface 34 of the housing 31 in the portion above the scraping member 51, is provided. The reflection portion 61 is a member for the oil coolant 41 splashed by centrifugal force from the scraping member 51 and supplying the oil coolant 41 to the coil 23 (coil end portion 23a).

In the example of FIG. 4(b), a recessed portion is formed on the inner circumferential surface 34 of the housing 31 in the portion above the scraping member 51 to serve as a reflection portion 62. The reflection portion 62 is also a member for reflecting the oil coolant 41 splashed by centrifugal force from the scraping member 51 and supplying the oil coolant 41 to the coil 23 (coil end portion 23a).

In both the example of the reflection portion 61 and the example of the reflection portion 62, by appropriately adjusting an attaching position and an angle of inclination, the oil coolant 41 splashed from the scraping member 51 is reflected and is supplied to the coil 23 (coil end portion 23a), and therefore it is possible to effectively cool the coil 23 (coil end portion 23a).

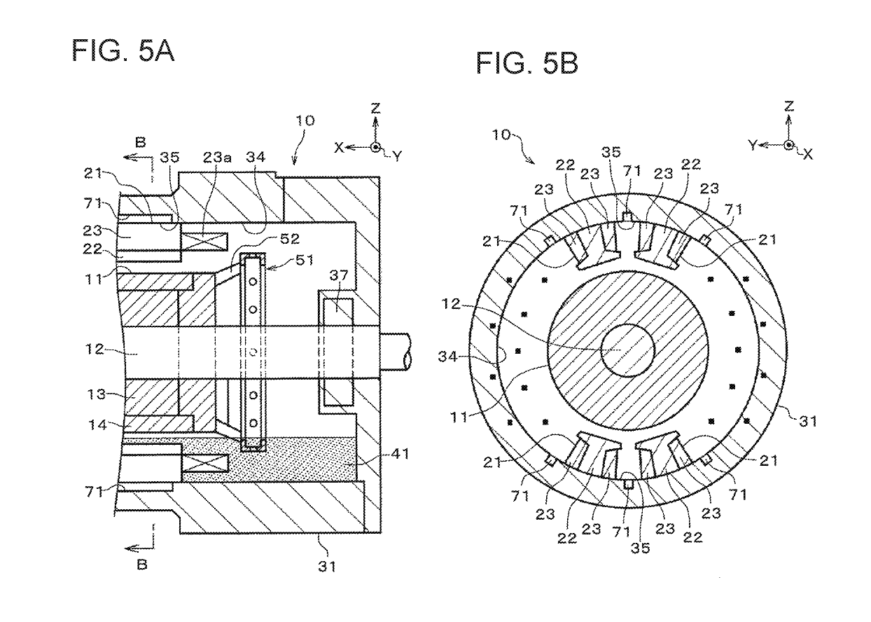

FIG. 5(a) is an enlarged longitudinal sectional view of a right part of the electric motor 10 according to a modification example of this example, and FIG. 5(b) is a sectional view taken along the line B-B in FIG. 5(a). In the example in FIG. 5, minute grooves 71 for supplying the oil coolant 41 to the coil (coil body portion) 23 are formed in stator slots 35 between adjacent teeth 22 on the inner circumferential surface 34 of the housing 31. Although FIG. 5(a) and FIG. 5(b) illustrate only the grooves 71 extending in a straight line in a crosswise direction, for example, the grooves 71 may diverge as appropriate so as to introduce the oil coolant 41 to the vicinity of the coil (coil body portion) 23, or a plurality of grooves 71 may be formed in the single stator slot 35.

When the minute grooves 71 are formed as described above, the oil coolant 41 is supplied to the vicinity of the coil (coil body portion) 23 due to capillary action, and therefore it is possible to adequately cool the coil (coil body portion) 23.

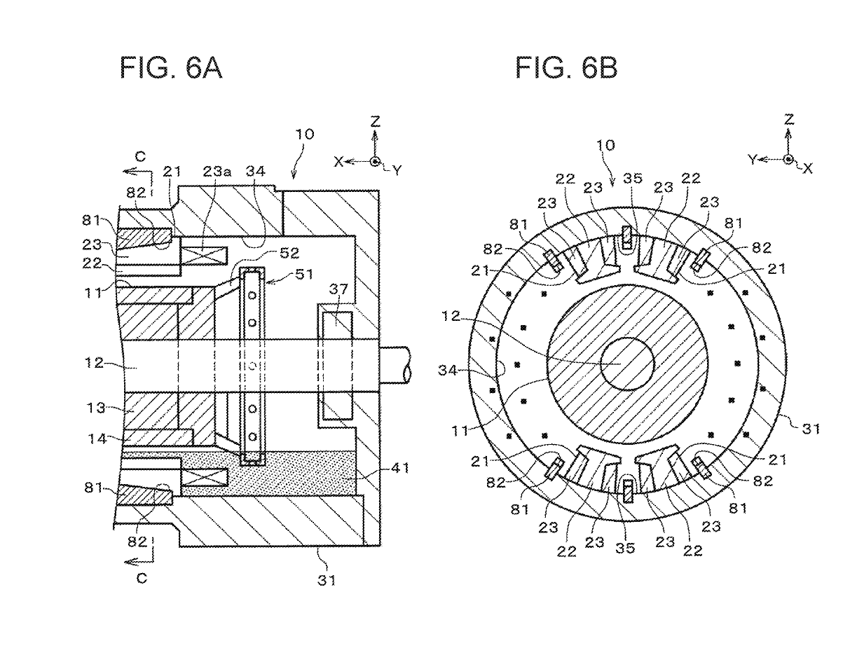

FIG. 6(a) is an enlarged longitudinal sectional view of a right part of the electric motor 10 according to a modification example of this example, and FIG. 6(b) is a sectional view taken along the line C-C in FIG. 6(a). In the example of FIGS. 6, projected portions 81 projected toward the rotor 11 are formed in the stator slots 35 between adjacent teeth 22 on the inner circumferential surface 31 of the housing 31. Tip end portions 82 on the rotor 11 side of the projected portions 81 have a projected height that is gradually higher (thickness is increased) from the scraping member 51 side toward the coil 23 side of the rotor 11 (from a right side toward a left side in the example of FIG. 6(a)) so as to be gradually closer to the rotor 11. That is, the tip end portions 82 are inclined, downward from the scraping member 51 side toward the coil 23 side of the rotor 11 on an upper side of the electric motor 10.

When the projected portions 81 are provided in the stator slots 35 that are not soaked in the oil coolant 41, the oil coolant 41 splashed from the scraping member 51 to adhere to the projected portions 81 flow from the scraping member 51 side toward the coil 23 side of the rotor 11 along the tip end portions 82 due to inclination of the tip end portions 82, and therefore the oil coolant 41 is supplied to the vicinity of the coil (coil body portion) 23, and therefore it is possible to adequately cool the coil (coil body portion) 23.

Note that both the grooves 71 in FIG. 5 and the projected portions 81 in FIG. 6 may be formed only on an upper side of the inner circumferential surface 34 of the housing 31 which is not soaked in the oil coolant 41 or may be formed over the whole circumference of the inner circumferential surface 34.

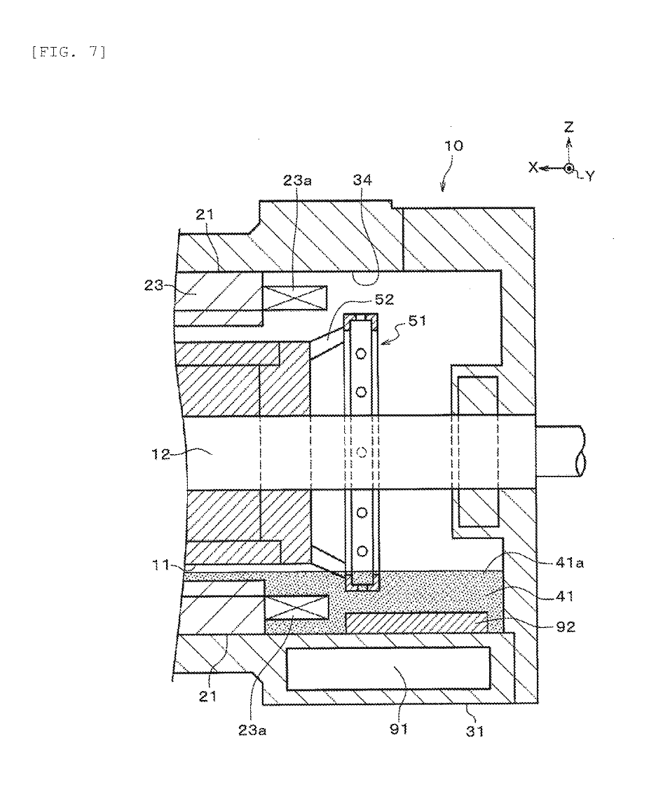

FIG. 7 is an enlarged longitudinal sectional view of a right part of the electric motor 10 according to a modification example of this example. In the example of FIG. 7, a cooling device 91 is provided in a lower portion of the housing 31 in which the oil coolant 41 stagnates. The cooling device 91 can be configured as a flow channel through which a coolant flows in order to cool the housing 31 by causing a coolant such as cooling water to flow in the housing 31. Alternatively, the cooling device 91 may be configured as a cooling fin formed on an outer circumferential surface of the housing 31 to cool the housing 31 by air-cooling by using air flowing outside the electric motor 10.

A cooling fin 92 is provided on the inner circumferential surface 34 of the housing 31 in the oil coolant 41 above the cooling device 91.

With this, the cooling device 91 cools the cooling fin 92. Meanwhile, the scraping member 51 not only scrapes up the oil coolant 41 but also stirs the ail coolant 41. Also by using this stirring of the oil coolant 41, the cooling fin 92 can effectively cool the oil coolant 41.

### Example 2

In this example, an example of an electric motor capable of providing an adequate amount of oil coolant to a coil of the electric motor by using a scraping member having a disk shape will be described.

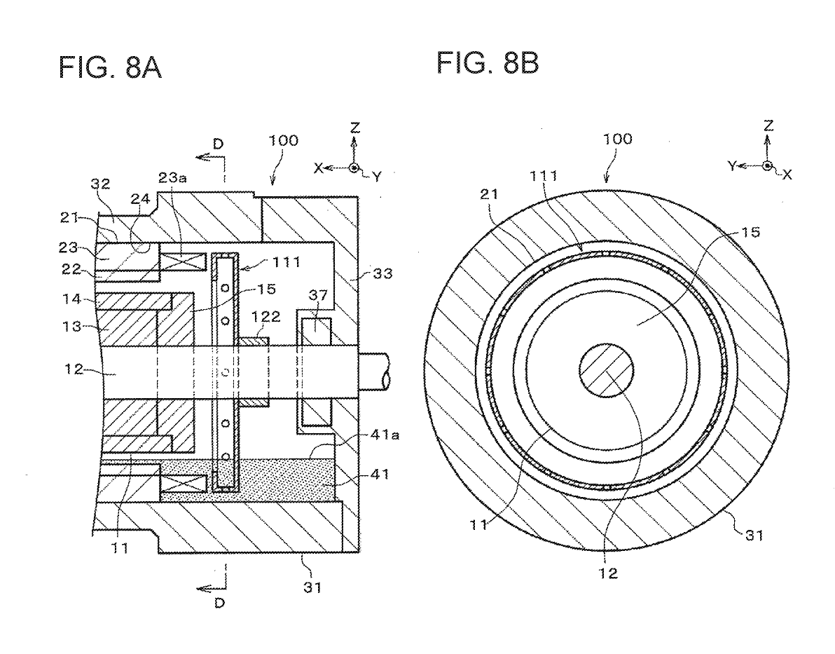

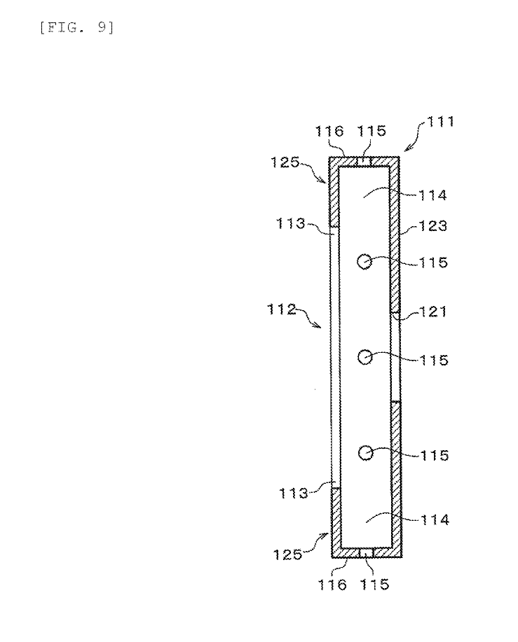

FIG. 8(a) is a longitudinal sectional view of a right part of an electric motor 100 according to this example. FIG. 8(b) is a sectional view taken along the line D-D in FIG. 8(a). This example is different from Example 1 in that scraping members 111 are provided instead of the scraping members 51. Other members same as those of the electric motor 10 in Example 1 are denoted by the same reference signs as the reference signs in Example 1 in the drawings, and detailed description thereof will be omitted. FIG. 9 illustrates the scraping member 111 which is longitudinally cut and is seen from the inner side in the radial direction.

A recessed portion 114 that forms an opening 113 serving as an inlet port of the oil coolant 41 is formed on an inner circumferential surface of the scraping member 111 in the radial direction of the rotating shaft 12 or on a surface of the scraping member 111 in the axial direction thereof (in this example, a side surface 112 in the axial direction). A plurality of oil introduction holes 115 passed from the inner side to the outer side in the radial direction of the rotating shaft 12 are formed in the recessed portion 114 at predetermined intervals.

Therefore, when the scraping member 111 rotated in conjunction with rotation of the rotor 11 is soaked in the oil coolant 41, the oil coolant flows through the opening 113 and the oil coolant 41 is scooped up by the recessed portion 114. Then, the oil coolant 41 in the recessed portion 114 is lifted upward in accordance with rotation of the scraping member 111 and is discharged by centrifugal force to the outside of the rotating shaft 12 in the radial direction through the oil introduction holes 115.

As described above, because the oil coolant is scooped up and is drawn up by the recessed portion 114 and the oil coolant is discharged by centrifugal force to the outside of the rotating shaft 12 in the radial direction through the oil introduction holes 115, it is possible to supply an adequate amount of oil coolant 41 to the coil 23 (in particular, coil end portion 23a) and adequately cool the upper part of the coil 23.

A portion of an outer circumferential surface 116 of the scraping member 111 in the radial direction of the rotating shaft 12, the portion being brought into contact with the oil coolant 41, has the same sectional shape in the axial direction of the rotating shaft 12 over the entire circumference except for portions where the oil introduction holes 115 are formed. In addition, the portion of the circumferential surface 116, which is brought into contact with the oil coolant 41, is equally distant from the center of rotation of the scraping member 111.

Thus, a surface shape and a size of the portion of the scraping member 111 to be sequentially soaked in the oil coolant 41 by rotation of the scraping member 111, a depth at which the portion thereof is immersed in the oil cool ant 41, and the like are always constant. Therefore, a resistance applied by the oil coolant 41 when the scraping member 111 rotates can be comparatively small, and rotation of the rotor 11 can be satisfactorily maintained.

The scraping member 111 has an insertion hole 121 at the center thereof, and the rotating shaft 12 is inserted into the insertion hole 121 so that the scraping member 111 is fixed to the rotating shaft 12 by a support member 122. The scraping member 111 has a disk shape (a reference sign 123 is a disk shape portion) and has the opening 113 on a surface on the stator 21 side in the axial direction of the rotating shaft 12 (in FIG. 8, a left surface of the scraping member 111).

Herein, the scraping member 51 in Example 1 described above has a circular shape and is supported by the support members 52 on a side portion (end ring 15) of the rotor 11. In the case where the scraping member 51 is supported by the support members 52 extending from the side portion of the rotor 11 as described above, extension of the support members 52 is limited to a certain degree. In the case where the support members 52 are too long, the support members 52 may be warped to shake the scraping member 51 when, for example, a sudden change in speed occurs due to high-speed rotation of the rotor 11. In order to prevent the above case, the support members 52 need to have a large size and be resistant to vibration and the like in some cases.

On the contrary, the scraping member 111 does not have such problems and can be attached by the support member 122 to various positions in the axial direction of the rotating shaft 12, and therefore it is possible to improve a degree of freedom of an attaching position thereof, as compared with the scraping member 51 in Example 1.

A peripheral portion 125 in the radial direction of the scraping member 111 is inwardly bent toward the coil 23 of the stator 21 to have a hook shape.

This can prevent outflow of the oil coolant 41 in the recessed portion 114, and therefore it is possible to cool the coil 23 with an adequate amount of oil coolant 41.

As in the example in FIG. 3(d) in Example 1, members corresponding to the partition members 58 may be provided between the oil introduction holes 115 in the recessed portion 114. The oil introduction holes 115, as well as the oil introduction holes 55 in FIG. 3(e) in Example 1, maybe directed toward the coil 23 (coil end portion 23a) of the stator 21.

Also in the electric motor 100, a height of the liquid surface 41a of the oil coolant 41 is set so as not to reach the outer circumferential surface of the rotor 11, which is similar to Example 1. Further, the reflection portion 61 or the reflection portion 62 similar to those of the modification examples of Example 1 may also be provided in the electric motor 100. Furthermore, the minute grooves 71 or the projected portions 81 similar to those of the modification examples of Example 1 may also be provided in the electric motor 100. Moreover, the cooling device 91 and the cooling fin 92 similar to those of the modification example of Example 1 may also be provided in the electric motor 100.

### Example 3

In this example, an example of an electric motor capable of providing an adequate amount of oil coolant to a coil of the electric motor by using a circular scraping member directly fixed to a rotor will be described.

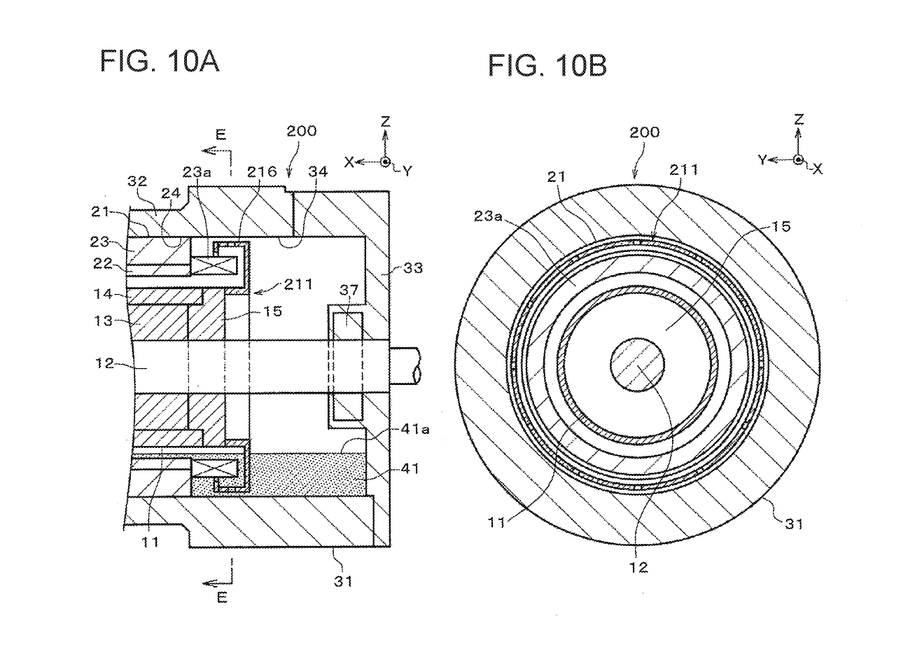

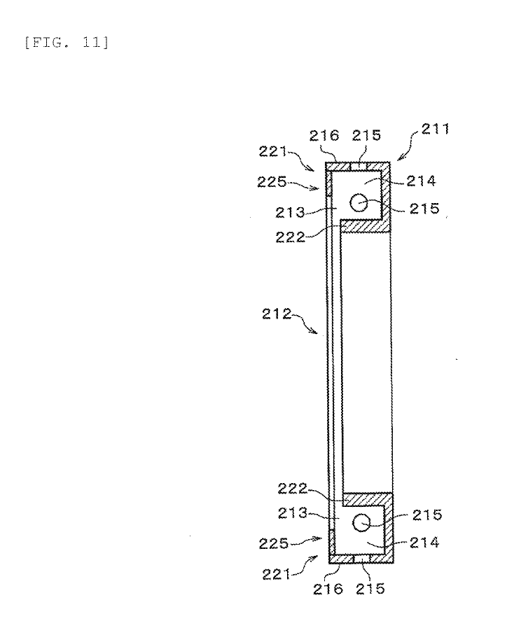

FIG. 10(a) is a longitudinal sectional view of a right part of an electric motor 200 according to this example. FIG. 10(b) is a sectional view taken along the line E-E in FIG. 10(a). This example is different from Example 1 in that scraping members 211 are provided instead of the scraping members 51. Other members same as those of the electric motor 10 in Example 1 are denoted by the same reference signs as the reference signs in Example 1 in the drawings, and detailed description thereof will be omitted. FIG. 11 illustrates the scraping member 211 which is longitudinally cut and is seen from the inner side in the radial direction.

A recessed portion 214 that forms an opening 213 serving as an inlet port of the oil coolant 41 is formed on an inner circumferential surface of the scraping member 211 in the radial direction of the rotating shaft 12 or on a side surface of the scraping member 211 in the axial direction thereof (in this example, a side surface 212 in the axial direction). A plurality of oil introduction holes 215 passed from the inner side to the outer side in the radial direction of the rotating shaft 12 are formed in the recessed portion 214 at predetermined intervals.

Therefore, when the scraping member 211 rotated in conjunction with rotation of the rotor 11 is soaked in the oil coolant 41, the oil coolant flows through the opening 213 and the oil coolant 41 is scooped up by the recessed portion 214. Then, the oil coolant 41 in the recessed portion 214 is lifted upward in accordance with rotation of the scraping member 211 and is discharged by centrifugal force to the outside of the rotating shaft 12 in the radial direction through the oil introduction holes 215.

As described above, because the oil coolant as scooped up and is drawn up by the recessed portion 214 and the oil coolant is discharged by centrifugal force to the outside of the rotating shaft 12 in the radial direction through the oil introduction holes 215, it is possible to supply an adequate amount of oil coolant 41 to the coil 23 (in particular, coil end portion 23a) and adequately cool the upper part of the coil 23.

A portion of an outer circumferential surface 216 (FIG. 10) (surface opposite to the inner circumferential surface 212) of the scraping member 211 in the radial direction of the rotating shaft 12, the portion being brought into contact with the oil coolant 41, has the same sectional shape in the axial direction of the rotating shaft 12 over the entire circumference except for portions where the oil introduction holes 215 are formed. In addition, the portion of the circumferential surface 216, which is brought into contact with the oil coolant 41, is equally distant from the center of rotation of the scraping member 211.

Thus, a surface shape and a size of the portion of the scraping member 211 to be sequentially soaked in the oil coolant 41 by rotation of the scraping member 211, a depth at which the portion thereof is immersed in the oil coolant 41, and the like are always constant. Therefore, a resistance applied by the oil coolant 41 when the scraping member 211 rotates can be comparatively small, and rotation of the rotor 11 can be satisfactorily maintained.

The scraping member 211 has a circular shape, and an inner side 222 is fixed to the end ring 15 of the rotor 11 so that an outer side 221 is projected toward an outer circumference of the rotor 11. The recessed portion 214 forms the opening 213 on the side surface 212 on the stator 21 side in the axial direction of the rotating shaft 12.

In Example 1 described above, the scraping member 51 is supported by the support members 52 projected toward the side portion of the rotor 11, and therefore the electric motor 10 needs to be increased in size in the axial direction of the rotating shaft 12 by as much as the support members 52 are projected.

On the contrary, in this example, the inner side 222 of the circular scraping member 211 is directly attached to the side portion of the rotor 11, and therefore a space for projecting the support members 52 is not needed. Thus, it is possible to reduce a size of the electric motor 200 in the axial direction of the rotating shaft 12 by as much as the support members 52 are projected.

In particular, in the scraping member 211, the coil end portion 23a of the rotor 11 enters the recessed portion 214 via the opening 213 (FIG. 10).

Therefore, it is possible to further reduce the size of the electric motor 200 in the direction of the rotating shaft 12.

The scraping member 211 is inwardly bent toward the coil 23 of the stator 21 to have a hook shape so that a circular outer circumferential portion 225 in the radial direction can hold the oil coolant 41 in the recessed portion 214.

This can prevent outflow of the oil coolant 41 in the recessed portion 214, and therefore it is possible to cool the coil 23 with an adequate amount of oil coolant 41.

As in the example in FIG. 3(d) in Example 1, members corresponding to the partition members 58 may be provided between the oil introduction holes 215 in the recessed portion 214. The oil introduction holes 215, as well as the oil introduction holes 55 in FIG. 3(e) in Example 1, may be directed toward the coil 23 (coil end portion 23a) of the stator 21.

Also in the electric motor 200, a height of the liquid surface 41a of the oil coolant 41 is set so as not to reach the outer circumferential surface of the rotor 11, which is similar to Example 1. Further, the reflection portion 61 or the reflection portion 62 similar to those of the modification examples of Example 1 may also be provided in the electric motor 200. Furthermore, the minute grooves 71 or the projected portions 81 similar to those of the modification examples of Example 1 may also be provided in the electric motor 200. Moreover, the cooling device 91 and the cooling fin 92 similar to those of the modification example of Example 1 may also be provided in the electric motor 200.

Note that the invention is not limited to the above examples and includes various modification examples. For example, the above examples have been described in detail to easily understand the invention, and therefore the invention is not necessarily limited to the examples having all the configurations described above. Further, a part of a configuration of a certain example can be replaced with a configuration of another example, and a configuration of another example can be added to a configuration of a certain example. Further, another configuration can be added to, removed from, or replaced with a part of the configuration of each example.

### REFERENCE SIGNS LIST

10 electric motor

11 rotor

12 rotating shaft

21 stator

23 coil

23a coil end portion

31 housing

35 stator slot

41 oil coolant

41a liquid surface

51, 111, 211 scraping member

53, 113, 213 opening

54, 114, 214 recessed portion

55, 115, 215 oil introduction hole

56 outer circumferential surface

57 inner circumferential surface

58 partition member

61, 62 reflection portion

71 groove

81 projected portion

82 tip end portion

91 cooling device

92 cooling fin

112 surface in axial direction of rotating shaft

125, 225 outer circumferential portion in radial direction of rotating shaft

212 side surface on stator side in axial direction of rotating shaft

222 inner side

1. An electric motor, comprising:
a rotor;
a stator surrounding the rotor;
a housing receiving the rotor and stator; and
a scraping member for scraping up an oil coolant stored in the housing while the scraping member is being rotated in conjunction with rotation of the rotor, the scraping member being provided on a side-portion side of the rotor a direction of a rotating shaft, wherein
the scraping member has a recessed portion that forms an opening serving as an inlet port of the oil coolant on an inner circumferential surface in a radial direction of the rotating shaft or on a side surface in an axial direction of the rotating shaft and has an oil introduction hole passed from an inner side to an outer side in the radial direction in the recessed portion.

2. The electric motor according to claim 1, wherein
a portion of an outer circumferential surface of the scraping member in the radial direction, the portion being brought into contact with the oil coolant, has the same sectional shape in the axial direction of the rotating shaft over the whole circumference and is equally distant from the center of rotation.

3. The electric motor according to claim 2, wherein
the scraping member has a plurality of the oil introduction holes in the recessed portion and has a partition member between the oil introduction holes.

4. The electric motor according to claim 2, wherein
in the scraping member, the oil introduction hole from the inner side to the outer side in the radial direction is directed toward a coil of the stator.

5. The electric motor according to claim 2, wherein
the scraping member has a disk shape whose center is fixed to the rotating shaft and has the opening on a surface in the axial direction of the rotating shaft.

6. The electric motor according to claim 2, wherein
the scraping member has a circular shape, and an inner side of the scraping member is attached to the rotor so that an outer side of the scraping member is projected toward an outer circumference of the rotor, and the recessed portion has the opening on the side surface in the axial direction.

7. The electric motor according to claim 6, wherein
in the scraping member, a coil end portion of the rotor enters the recessed portion via the opening.

8. The electric motor according to claim 5, wherein
the scraping member is inwardly bent toward a coil of the stator to have a hook shape so that an outer circumferential portion of the scraping member in the radial direction can hold the oil coolant in the recessed portion.

9. The electric motor according to claim 1, wherein
a liquid surface of the oil coolant stored in the housing has a height that does not reach an outer circumferential surface of the rotor.

10. The electric motor according to claim 1, wherein
a reflection portion for reflecting the oil coolant splashed from the scraping member toward a coil of the rotor is formed on an inner circumferential surface of the housing.

11. The electric motor according to claim 1, wherein
a groove for supplying the oil coolant to a coil of the rotor is formed in a stator slot on an inner circumferential surface of the housing.

12. The electric motor according to claim 1, wherein
a projected portion projected toward the rotor is formed on a stator slot on an inner circumferential surface of the stator, and a tip end portion of the projected portion is gradually closer to the rotor from the scraping member side to a coil side of the rotor.

13. The electric motor according to claim 1, wherein:
a cooling device is provided in the housing below the oil coolant; and
a cooling fin is provided in the oil coolant above the cooling device.

14. A scraping member, wherein:
the scraping member is provided on a side-portion side of a rotor of an inner rotor electric motor in a direction of a rotating shaft;
the scraping member has a recessed portion that forms an opening serving as an inlet port of an oil coolant stored in a housing of the electric motor on an inner circumferential surface in a radial direction of the rotating shaft or on a side surface in an axial direction of the rotating shaft and has an oil introduction hole passed from an inner side to an outer side in the radial direction in the recessed portion; and
the scraping member scrapes up the oil coolant while being rotated in conjunction with rotation of the rotor.

15. A rotor, comprising:
a rotor main body of an inner rotor electric motor; and
a scraping member provided on a side-portion side of the rotor main body in a direction of a rotating shaft, having a recessed portion that forms an opening serving as an inlet port of an oil coolant stored in a housing of the electric motor on an inner circumferential surface in a radial direction of the rotating shaft or on a side surface in an axial direction of the rotating shaft, having an oil introduction hole passed from an inner side to an outer side in the radial direction in the recessed portion, and scraping up the oil coolant while being rotated in conjunction with rotation of the rotor.
